(19) United States
(12) Patent Application Publication
(10) Pub. No.: US 2016/0240035 A1
(43) Pub. Date: Aug. 18, 2016

(54) Gaming Table System for Error Reduction and Efficiency

(71) Applicant: THE UNITED STATES PLAYING CARD COMPANY, Erlanger, KY (US)

(72) Inventors: Lance Merrell, Union, KY (US); Ken Miller, Cincinnati, OH (US); Carol Rouillard, Loveland, OH (US); Todd Brainard, Crescent Springs, KY (US); Mohit Ahuja, Huber Heights, OH (US)

(73) Assignee: The United States Playing Card Company, Erlanger, KY (US)

(21) Appl. No.: 15/030,320

(22) PCT Filed: Nov. 13, 2014
(86) PCT No.: PCT/US14/65354

§ 371 Date: Apr. 18, 2016

Related U.S. Application Data
(62) Division of application No. PCT/US2014/024525, filed on Mar. 12, 2014.
(60) Provisional application No. 61/904,193, filed on Nov. 14, 2013.

(51) Int. Cl. G07F 17/32; A63F 1/18; A47B 25/00

(52) U.S. Cl. CPC G07F 17/322; A47B 25/00; A63F 1/18; G07F 17/3293; A63F 2009/2489

(57) ABSTRACT

A gaming table system for error reduction and efficiency are disclosed. The gaming table system include a gaming table can have sensors for determining the values of the dealt cards. Additional table sensor can use used to determine the players bet and prospective payout. Intelligent markers can be integrated with the system, where the markers preferably include a mechanism for signaling the receiving bettor to acknowledge receipt of the marker, which acknowledgement may turn off the indicating mechanism. The method of indication could be visual, audible or otherwise which would signal a bettor to interact with the marker. The intelligent markers communicate with table sensors and a shoe to monitor the status of games, and to signal alerts when a mistake occurs.

### FIELD OF THE INVENTION

The present invention generally relates to playing card gaming tables, and more particular to an intelligent game table which can monitor players and dealers to reduce errors and increase efficiency.

### BACKGROUND OF THE INVENTION

In casinos, gaming tables are utilized for playing card games. For example, FIG. 1 shows a prior art Baccarat table 100, which includes a chip case 105 and a shoe 110. In the game of Baccarat, acrylic markers are used to designate the highest bettor for Player and Banker hands. The markers are of two different colors and reside in front of the appropriate bettor(s) to mark the correct spot that the cards should go to for each hand. Also, there is an outline or colored spot that represents the “home” spot for each marker on the table, typically directly in front of the dealer. This outline is where the markers reside at certain times, cards for each marker are typically placed in these spots (or immediately adjacent to these spots) at different times during the game. As shown in FIG. 1, the Banker marker 125 is visible in the Banker outlined spot 115, and the Player marker 130 is visible in the Player outlined spot 120.

After bets are placed, but before cards are dealt, one or both of the markers should be passed to bettor(s) who bet the highest amount on Player and/or Banker. As can be seen in FIG. 1, each bettor sits at a portion of the table which is often labeled with both a “Player” area 135 and a “Banker” area 140, as any bettor could be the Player or the Banker on any given hand. Depending on the pre-deal betting, the Banker marker 125 is moved to the Banker area 140 of the appropriate bettor, while the Player marker 130 is moved to the Player area 135 of the appropriate bettor.

As the first 4 cards are dealt from the shoe 110, they are placed alternately by the dealer at the Player and Banker spots 145, 150 on the table 100 until all of the four cards are drawn. After all of the four cards are dealt from the shoe 110, one or both hands should be pushed to the bettors holding the respective markers 125, 130 for that hand.

### SUMMARY OF THE INVENTION

This invention relates generally to intelligent game tables which can monitor players and dealers to reduce errors and increase efficiency. In one embodiment, the invention includes intelligent markers which are effectively “player acknowledgement” indicators. The markers preferably include a mechanism for signaling the receiving bettor to acknowledge receipt of the marker, which acknowledgement may turn off the indicating mechanism. The method of indication could be visual, audible or otherwise which would signal a bettor to interact with the marker. For example, the bettor may have to press a button on the marker (or the marker itself) which preferably causes a visible or audible change in the marker that is perceptible to all at the table. For example, a light may go from “on” to “off’ or “off’ to “on,” or may switch from one color to another, or may vibrate until acknowledged by the bettor.

The markers may each include a motion/location/vibration sensor, accelerometer, touch sensor, microphone, or combination of different sensing technologies for obtaining feedback from movement of or interaction with the marker during the game. The method of acknowledgement could therefore be a simple touch from the bettor, activating or pushing a button or touch screen, tapping, or any other method where physical contact with the device by the player or dealer is necessary. Verbal or gesture-based acknowledgement is also envisioned. Alternatively, acknowledgement may not come from the user, but may instead come simply from monitoring positional/location information relating to the marker, and determining that the marker has been placed in the correct location. Such acknowledgement may be recorded and saved by the markers and/or related equipment, such as overhead cameras, to prevent disputes. Any sensors in the markers preferably communicate with the system and/or shoe using wireless technology (such as RF). The player acknowledgement may be communicated back to the shoe, which would then be used to control the continuation of the game. For example, if the shoe doesn't receive the bettor's acknowledgement regarding correct marker distribution, it would prevent the game from continuing by triggering an alarm or an alert, or by engaging a blocking mechanism such as by closing a gate of the shoe.

In another embodiment, the system may utilize different sensing technologies for tracking movement of the cards during the game. For example, the various spots on the table where the cards are to be placed during the game (e.g., Player and Banker sports 145, 150) can include embedded sensors or sensing pads. Such sensors may be utilized to track placement of cards, and may include optical cameras, proximity sensors, barcode readers, touch sensors or the like that are capable of determining or decoding the card value and/or detecting the cards presence when the cards are placed during the game.

Further, rather than having fixed spots on the table for each hand, the spots can be variable by having an electronic display embedded into the table or the pad. In such an embodiment, the name of the hand to be displayed may be controlled by the position of markers on the table. The table sensors or the sensor pad will send feedback to the shoe through wired or wireless technologies.

In one embodiment, a system for reducing card distribution errors comprises a shoe and an intelligent marker. The intelligent marker includes at least one position sensor for determining the position of the intelligent maker, and a communications unit for electronically communicating with the shoe. The intelligent marker also preferably includes an acknowledgement detector for detecting an acknowledgement from a bettor, an indicator, and a processor for receiving position data from the position sensor. The processor is preferably in communication with the shoe via the communications unit. Preferably, the indicator is enabled when the intelligent marker is to be given to a bettor, and is disabled upon detection of an acknowledgement from the bettor.

In another embodiment, a method for reducing card distribution errors comprising several steps. In a first step, a dealer is allowed to distribute at least one marker to at least one bettor. In a second step, the indicator in the marker is enabled, and a gate of the associated shoe is closed. In a third step, the marker accepts an acknowledgement from a bettor. In a fourth step, the indicator in the marker is disabled, and the gate of the shoe is opened upon recognition of the acknowledgement from the bettor.

Other and further objects of the invention, together with the features of novelty appurtenant thereto, will appear in the course of the following description.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates an example prior art Baccarat table;

FIG. 2 illustrates a block diagram of an example system according to an embodiment;

FIG. 3 is a perspective view of an intelligent card shoe as connected to a game controller unit;

FIG. 4 is a perspective view of the shoe of FIG. 3 focused on the card guide section thereof;

FIG. 5A is a perspective view of the intelligent card shoe dispensing portion of a shoe, having a friction pad;

FIG. 5B is a side cross-sectional view of an intelligent card shoe dispensing portion of a shoe, having a friction pad;

FIG. 6 illustrates a block diagram of an example intelligent marker according to an embodiment;

FIG. 7 illustrates a block diagram of an example table according to an embodiment;

FIG. 8 illustrates a flow chart of a process for using markers to require acknowledgement from bettors, according to an embodiment;

FIG. 9 illustrates a flow chart of an example process 600 during a game of Baccarat.

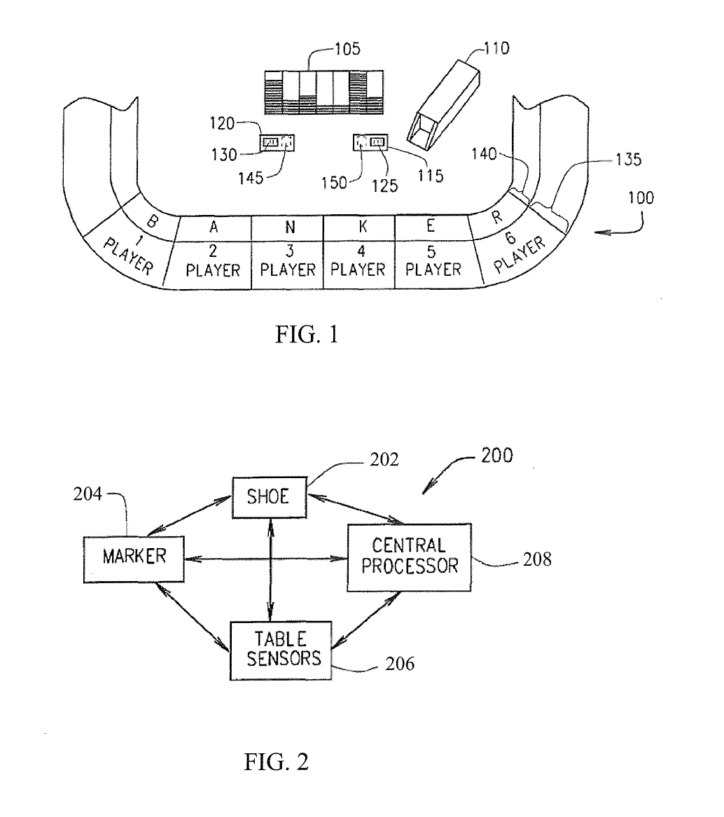

### DETAILED DESCRIPTION OF THE INVENTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

FIG. 2 illustrates a block diagram of an example system 200 according to an embodiment of the present invention. As shown, an intelligent card shoe 202 is in communication with at least one marker 204. Such communication is preferably wireless, as would be understood by one of ordinary skill in the art. The intelligent card shoe 202 may also be in communication with table sensors 206, when present, and such communication may be wired or wireless. In any case, some or all of the intelligent card shoe 202, marker 204, and table sensors 206 may also be in communication with a central processor 208. Although such a central processor 208 is not necessary, as any of the individual components 202, 204, 206 may include sufficient processing power to accomplish the tasks hereof, many casinos utilize central processors 208 and servers and the like to monitor and/or process data from various tables. In this regard, the central processor 208 may be built into any of the above discussed components, or into the table itself, or may be included in a stand-alone computer system as would be understood. For the purposes hereof, it will be understood that substantive processing may be handled at a table, e.g., by the intelligent card shoe 202 or by a processor built into or associated with the table, such that the central processor 208 merely monitors actions at the table and/or is alerted to problems at the table. Alternatively, substantive processing may be offloaded to the central processor 208, or there may be a combination of substantive processing in various locations.

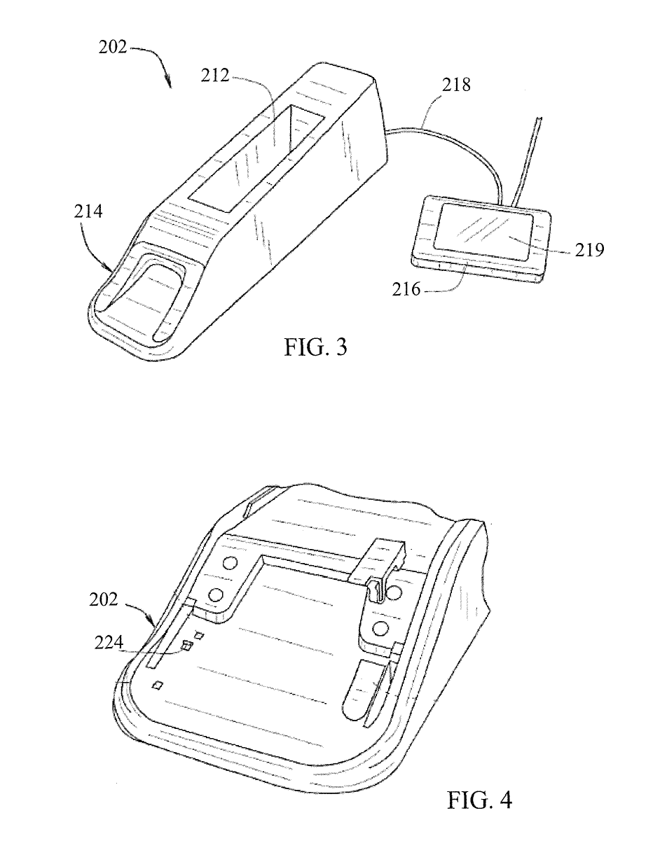

Referring to FIG. 3, the intelligent card shoe 202 can include a card cradle 212 and a card dispensing portion 214. A cover is removeably positionable over the card cradle 212, limiting access to the cards. An alarm can be connected to the cover, providing notification when the cover is removed. Additionally, the cover can include a locking mechanism, preventing unauthorized access to the cards. The intelligent card shoe 202 is connected to and in electrical communication with a game controller unit 216 via a cable 218. The game controller unit 216 may include a display 220. The cable may be a standard Ethernet cable, a USB cable, or any other cabling sufficient to allow communication between the intelligent card shoe 202 and the game controller unit 216. The cable 218 allows the game controller unit 216 to be in data communication with the intelligent card shoe 202 such that electronic information can be passed between the intelligent card shoe 202 and game controller unit 216 via cable 218. The game controller unit 216 may also be incorporated into the intelligent card shoe 202.

The intelligent card shoe 202 holds playing cards 220, which include encryption which can be used to represent card rank and suit information. Normally, such information is invisible to the naked eye so as not to interfere with the standard aesthetics or functionality of the card, and so as not to be easily discerned by players. The encryption typically contains information regarding the rank and suit of the card, or other information. Current encryption techniques use bar codes on the edges of cards, ultra violet (“UV”) reaction codes, printed micro-dots, reactive ink, infrared taggants used with the playing card or ink, RFID chips, and other known methods.

The intelligent card shoe 202 can include a card removal limiter 220 which can be used to prevent the removal of a playing card 220 from the card dispensing portion 214 of the intelligent card shoe 202, or in the alternatively, provide a tactile indication to the dealer that a playing card 220 should not be removed from the card dispensing portion 214 of the intelligent card shoe 202. The card removal limiter 222 can be controlled by the control 216 and an operated in accordance with the rule of a card game, or in response to an action by the dealer.

Referring to FIG. 4, the card removal limiter 222 can be a card gate 224 which can be actuated between a closed (raised) and open (lowered) position. Chiefly, the card gate 224 prevents cards from being inadvertently pulled out of the intelligent card shoe 202 even after the game outcome is decided. Card overdraw, as this is called, is a common mistake at game tables and can unnecessarily disrupt the progress of the game at the table. The game controller unit 216 also reminds the dealer to collect commissions when the game played at the table is Commission Baccarat.

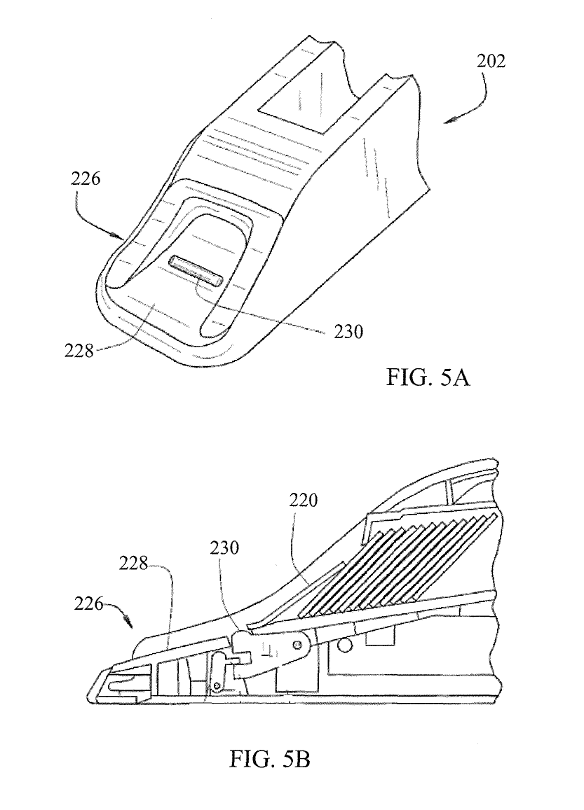

In another embodiment, as shown in FIGS. 5A and B, the card removal 222 limiter can take the form of the a card dispensing portion 226 with a card travel surface 228 having a card pull difficulty mechanism which makes removing a card 220 from the intelligent card shoe 202 more difficult, but which does not prevent the same. Such additional resistance may be created by increasing friction upon removal of the card 220 from the card dispensing portion 226. Generally, the normal pull force required to remove a card is between about 120 to 180 grams. In a preferred embodiment, increasing the friction associated with a card pull results in a required pull force of between about 400 and 600 grams.

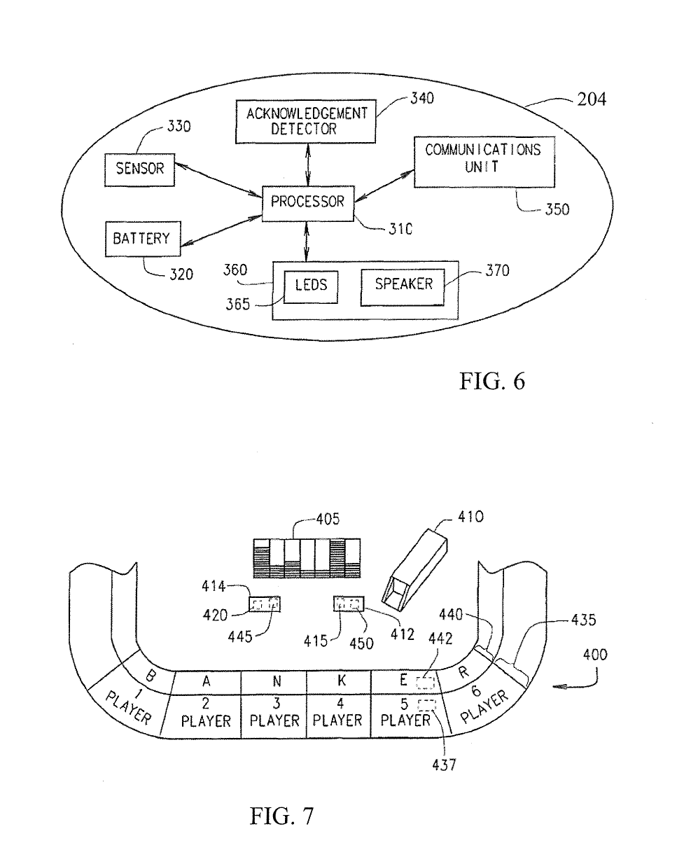

Referring to FIG. 6, illustrates a block diagram of an example intelligent marker 204. The intelligent marker 204 may include a processor 310, which may be a central processing unit or merely a microcontroller, as would be understood. Processor 310 is preferably in electrical communication with a battery 320, as well a sensor 330. Sensor 330 may include various sensors, such as an accelerometer, a proximity sensor, a sensor for tracking the exact position of the marker 204, an auditory sensor, etc. An acknowledgement detector 340 such as a push-button switch may also be in communication with the processor 310. Acknowledgement detector 340 may be separate from sensor 330, or sensor 330 could serve as an acknowledgement detector 340 as well. Marker 204 also includes a communications unit 350, which is preferably a wireless communication unit capable of communication via WI-FI, Bluetooth, or the like. Communications unit 350 may also be a hardwired communications unit, although wireless communication is preferred, as discussed above. Marker 204 may also include indicators 360, such as LEDs 365 and a speaker 370, and/or other mechanisms for signaling an alert to players and the dealer such as via vibration.

The above mentioned components may be interconnected via one or more circuit boards in marker 204. In one example embodiment, the circuit board may include six LEDs 365, with two visible from the top of the marker 204 and four visible from the bottom of the marker 204. Marker 204 may have a frosted middle section which houses the circuit board and components, and thinned or transparent top and bottom sections which allow the LEDs to be visible. Various portions of the marker 204 may be composed of materials such as plastic, metal, porcelain, wood, composite materials, or any other desired material. The LEDs 365 can be programmed to blink or remain solid on activation, and can be programmed for different color options. LEDs 365 may also be programmed to indicate that the batteries 320 are low.

In one non-limiting embodiment, the marker may include one or two push-button switches 340 and an accelerometer 330 which can all be used to enable and disable the LEDs 365. For example, the push-button switches 340 may be used by the dealer before passing out the markers 204 to enable the LEDs 365 and cause them to signal for an acknowledgement from the appropriate bettor, and may disable the LEDs 365 when the bettor acknowledges the marker 204 by pressing it. Further, the marker 204 may be flipped upside down to indicate a winning hand, such that the accelerometer 330 enables the LEDs 365 upon flipping to celebrate the winning hand. In another non-limiting example, the accelerometer or other internal sensors 330 may detect movement of the marker 204 as the dealer pushes the marker 204 toward the bettor, and may enable the LEDs 365 to signal for an acknowledgement from the bettor. The indicator 360 may also be triggered externally.

FIG. 7 illustrates a block diagram of an example table 400 which includes table sensors 206. Table 400 includes a chip case 405, as well as a shoe 410. Preferably, the shoe 410 is in communication with various other components as shown in FIG. 2 above. Rather than mere home locations 412, 414 for markers 204, table 400 may include sensors 415, 420, which may include one or more specialized sensor pads at the home locations for the markers 204. Such sensors 415, 420 are preferably capable of determining when markers 204 have been placed on their respective home locations, and can cause the indicators 360 in the markers 204 to enable when the markers 204 should be located on their home locations but are not. Player area 435 and Banker area 440 may also include similar sensors and/or specialized pads 437, 442 to determine when the markers 204 have been moved from their home positions to a bettor's Player/Banker area 435, 440, as appropriate. When a bettor's Player/Banker area 435, 440 detects one of the markers 204, a display associated with that bettor may indicate that the bettor is the Player or Banker based on the marker 204 detected.

Similarly, the Player and Banker card spots 445, 450, and any other spots at which cards may be placed during a game, may also include such sensors and/or specialized pads 437. These embedded sensors may determine when cards are present, but preferably are also capable of determining the rank and suit of the placed cards. As such, the sensors at these card spots 445, 450, etc., may include optical cameras, proximity sensors, barcode readers, touch sensors and the like.

Additionally, the specialized pads 437 may include bet pads on which a bettor places a bet during a game. The bet pad can include imbedded sensors which may determine when bets are present, but preferably are also capable of determining the amount of the bet. Such information is usable to determine the highest better, and calculate the appropriate payout in the event a bettor wins. As such, the sensors at these bet pads may include optical cameras, proximity sensors, barcode readers, touch sensors and the like. Each such sensor and/or specialized pad is considered a table sensor 206, as discussed above in connection with FIG. 2.

The chips used on the table 400 can include encryption which can be used to represent chip value and are readable by the table sensor 206. Normally, such information is invisible to the naked eye so as not to interfere with the standard aesthetics or functionality of the chips, and so as not to be easily discerned by players. Current encryption techniques use bar codes on the edges of cards, ultra violet (“UV”) reaction codes, printed micro-dots, reactive ink, infrared taggants used within the chip or ink, RFID chips, and other known methods.

The system 200, markers 204, and table 400 allow the game to progress without much additional work on the part of the dealer or bettors. During a game of Baccarat, after the bets have been placed, the dealer would give the respective markers 204 to the appropriate highest bettors. The dealer may actively trigger indicators 360, such as LEDs 365 and/or speaker 370 embedded in the markers 204. Alternatively, the dealer may trigger such indicators 360 simply by moving the markers 204 from their respective home positions 415, 120 to the appropriate bettor's positions 435, 440, in which case sensors 330 embedded in the markers 204 and/or sensors 437, 442 in the table may sense movement and/or placement of the markers 204 and activate the indicators 360. The indicators 360 then attract the bettor and/or dealer attention towards the hand to which the markers 204 belong. The recipient bettor of one or both markers 204 would then acknowledge receipt of the marker 204 to stop the indicators 360. For example, the recipient bettor may physically press the marker 204, such that the acknowledgement detector 340, e.g., a push-button switch, recognizes the acknowledgement, and processor 310 ceases the LEDs 365 from blinking or the speakers 370 from emitting an audible noise.

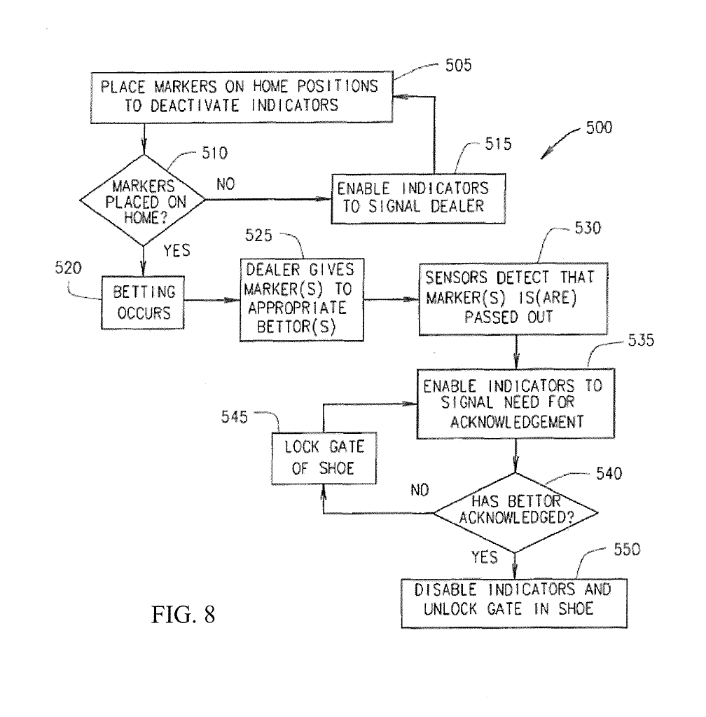

Such acknowledgement would allow the game to continue. If the bettors don't acknowledge the receipt of the correct marker 204, the shoe 210 may prevent the dealer from drawing additional cards, or may otherwise alert the dealer to the lack of acknowledgement. Once the bettor confirms the receipt of correct marker, the marker(s) would transmit the acknowledgement confirmation, possibly with their respective locations, back to the shoe. Such a process is shown in FIG. 8.

FIG. 8 illustrates a flow chart of an example process 500 for using markers 204 to require acknowledgement from bettors. At step 505, before a game has begun, the markers 204 should be placed on their home positions 415, 420. This should deactivate any indicators 360 which remain engaged. At step 510, a check is done to determine whether the markers 204 have actually been placed on their home locations 415, 420. This determination may be made via table sensors 230 capable of detecting whether the markers 204 have been properly placed, or via sensors 330 in the markers 204, or via another tracking system such as overhead cameras or the like. If the markers 204 are still not properly placed, at step 515, the marker 204 enables its indicators 360 to call the dealer's attention to the fact that the marker 204 is misplaced. The process then reverts to step 505. However, at step 510, if the markers 204 are properly placed on their home positions 415, 420, the process continues.

At step 520, betting occurs. At step 525, the dealer gives one or both of the markers 204 to the appropriate bettor or bettors, moving the markers 204 to positions 437, 442 with the appropriate bettor. At step 530, sensors 230 detect whether the markers have been appropriately moved. As above, such sensors may be table sensors 230 or sensors 330 in the marker 204. For example, sensor 330 in the marker 204 may include an accelerometer which detects the physical movement of the marker 204. Alternatively, as noted above, table sensors 230 may include a specialized pad or other sensor which detect the presence of a marker 204 at positions 437, 442. In any case, once it is detected that the markers 204 have been passed out, at step 535 the indicators 360 in the markers 204 are enabled to signal the need for acknowledgement from the appropriate bettors. As discussed above, preferably bettors may acknowledge the markers by pressing them, such that acknowledgement detector 340 in the marker 204 registers the acknowledgement via a push-button switch. However, other forms of acknowledgement are envisioned, such as verbal acknowledgement or another movement of the marker 204, etc. If the bettors do not acknowledge the markers 204, at step 545 the maker 220 communicates with shoe 210 and the shoe closes its gate to prevent cards from being withdrawn. The process then reverts to step 535 with the indicators remaining enabled. This should grab the attention of the dealer and/or bettors if a marker has been mistakenly passed out, so that the marker position can be corrected. Once the bettors acknowledge the markers 204, the process proceeds to step 550 and the indicators 360 in the markers 204 are disabled. The markers 204 preferably also signal the shoe to unlock the gate, so that the game may proceed.

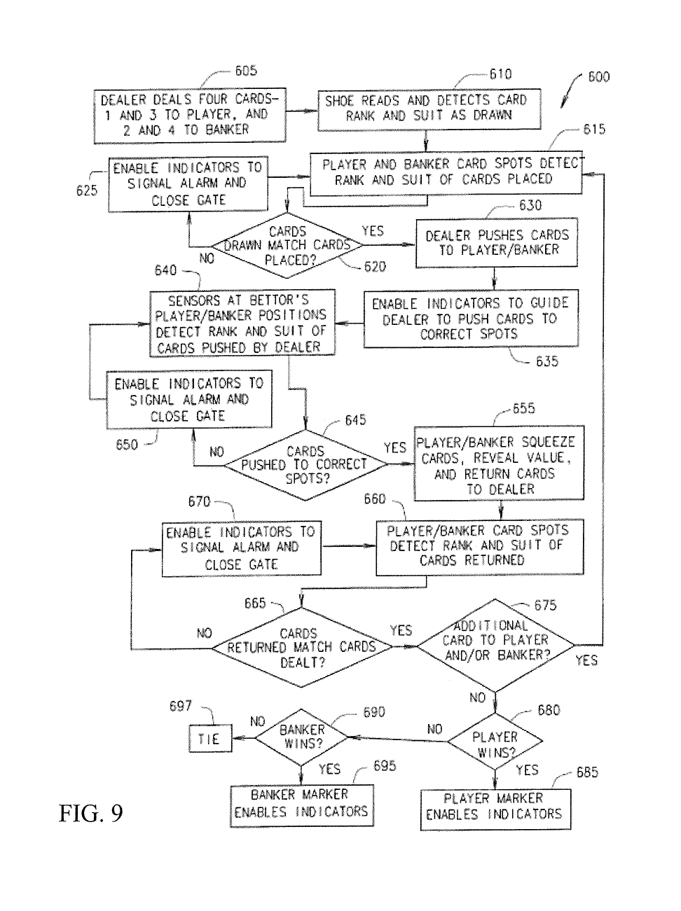

FIG. 9 illustrates a flow chart of an example process 600 during a game of Baccarat, generally after the process 500 of FIG. 5 has concluded and the markers 204 have been appropriately given to the correct bettors. At step 605, the dealer deals four cards, with the first and third going to the Player and the second and fourth going to the Banker. At step 610, the shoe reads the cards as they are drawn, and detects the cards' ranks and suits, according to known methods. At step 615, as the cards are placed on the Player and Banker card spots 415, 420, the table sensors 230 detect the rank and suits of the cards placed. At step 620, a determination is made as to whether the cards drawn match the cards as placed. Where the cards placed do not match the cards drawn (either in rank, suit, or order), at step 625 the indicators 360 are enabled to signal an alarm, and the gate of shoe 210 is closed. The process then allows the dealer to correct the mistake, and reverts back to step 615 to again check the cards as they are now placed on the Player and Banker card spots 415, 420. Once the cards placed match the cards drawn, the process advances.

At step 630, the dealer pushes the cards to the Player and Banker, respectively. At step 635, the indicators 360 on the markers 204 are enabled sequentially to guide the dealer to push the cards to the correct spots. At step 640, table sensors 230 at the Player/Banker positions 437, 442 detect the rank and suits of the cards pushed by the dealer, and at step 645 a determination is made as to whether the cards were pushed to the correct spots. When the cards were pushed to incorrect spots, at step 650 the indicators 360 are enabled to signal an alarm, and the gate of shoe 210 is closed. The process then allows the dealer to correct the mistake, and reverts back to step 640 to again check the cards as they are now placed on the Player and Banker positions 437, 442. Once the cards have been pushed to the correct locations, the process advances.

At step 655, the Player and Banker squeeze the cards revealing the cards' ranks and suits, and return the cards to the dealer. At step 660, the dealer places the cards back onto the Player and Banker card spots 415, 420. As above, at step 665, a determination is made as to whether the cards returned to the dealer and placed on the Player and Banker card spots 415, 420 match the cards as drawn. Where the cards placed do not match the cards drawn (either in rank, suit, or order), at step 670 the indicators 360 are enabled to signal an alarm, and the gate of shoe 210 is closed. The process then allows the dealer to correct the mistake, and reverts back to step 660 to again check the cards as they are now placed on the Player and Banker card spots 415, 420. Once the cards placed match the cards drawn, the process advances.

At step 675, the system determines whether the Player and/or Banker need an additional card. Where additional cards are needed, the process reverts back to step 615 with the drawing and placing of one or two new cards. Once no additional cards are needed, the process advances to step 680 for a determination as to whether the Player wins. If so, at step 685, the Player marker 204 enables its indicators. If not, at step 690 a determination is made as to whether the Banker wins. If so, at step 695 the Banker marker enables its indicators. If not, at 697 there has been a tie (or stand-off).

The various system examples shown above illustrate a novel system and method. A user of the present invention may choose any of the above embodiments, or an equivalent thereof, depending upon the desired application. In this regard, it is recognized that various forms of the subject invention could be utilized without departing from the spirit and scope of the present invention.

From the foregoing it will be seen that this invention is one well adapted to attain all ends and objects hereinabove set forth together with the other advantages which are obvious and which are inherent to the structure. It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative, and not in a limiting sense.

What is claimed is:

1. A system for reducing card distribution errors comprising:
a gaming table including a plurality of sensors;
an intelligent marker selectively positionable on the gaming table, and
a processor in communication with the plurality of sensors and the intelligent marker.

2. A system for reducing card distribution errors as set forth in claim 1, wherein the gaming table includes a plurality of player bet pads, each of the plurality of bet pad having a gaming chip detection sensor.

3. A system for reducing card distribution errors as set forth in claim 2, further comprising a plurality of gaming chips, wherein each of the plurality of gaming chips are encoded with a value.

4. A system for reducing card distribution errors as set forth in claim 3, wherein the gaming chip detection sensor can read the values of one or more of the gaming chips positioned on the bet pad.

5. A system for reducing card distribution errors as set forth in claim 4, wherein the gaming chip detection sensor can be an optical camera, a proximity sensor, a barcode reader, touch sensor, or an RFID sensor.

6. A system for reducing card distribution errors as set forth in claim 1, the gaming table further including a banker card pad and a player card pad, each of the banker card pad and player card pad including a playing card detection sensor.

7. A system for reducing card distribution errors as set forth in claim 6, wherein the playing card detection sensor can detect the presence of a playing card.

8. A system for reducing card distribution errors as set forth in claim 6, where the playing card detection sensor can determine the rank of a playing card.

9. A system for reducing card distribution errors as set forth in claim 8, wherein the playing card detection sensor can be an optical camera, a proximity sensor, a barcode reader, touch sensor, or an RFID sensor.

10. A system for reducing card distribution errors as set forth in claim 1, wherein the gaming table includes a plurality of marker pads, wherein each of the marker pads include a marker detection sensor.

11. A system for reducing card distribution errors as set forth in claim 10, wherein the marker detection sensor can detect the presence of the intelligent marker.

12. A system for reducing card distribution errors as set forth in claim 11, where the marker detection sensor can determine the type of intelligent marker.

13. A system for reducing card distribution errors as set forth in claim 1, further comprising an intelligent playing card shoe, where in the intelligent playing card shoe in is communication with the processor.

14. A system for reducing card distribution error as set forth in claim 13, wherein the intelligent playing card shoe includes:
a card cradle for holding the playing cards,
a card removal portion for allowing the playing cards to be manually removed from the shoe, and
a card reading sensor for reading the rank of the playing card as the playing card is drawn out of the card removal portion.

15. A system for reducing card distribution error as set forth in claim 1, wherein the intelligent marker includes:
at least one position sensor for determining the position of the intelligent maker;
a communications unit for electronically communicating with the processor;
an acknowledgement detector for detecting an acknowledgement from a bettor;
an indicator; and
wherein the indicator is enabled when the intelligent marker is to be given to a bettor, and
wherein upon detection of an acknowledgement from the bettor, the indicator is disabled.

16. A system for reducing card distribution error as set forth in claim 15, wherein the indicator is enabled upon the at least one position sensor detecting that the position of the intelligent marker has been moved from a home position for the marker.

17. A system for reducing card distribution error as set forth in claim 15, wherein the indicator is enabled by the dealer.

18. A system for reducing card distribution error as set forth in claim 15, wherein the indicator is enabled via the acknowledgement detector by the dealer.

19. A system for reducing card distribution error as set forth in claim 1, further comprising a display unit connected to the processor.
